(19) United States
(12) Patent Application Publication
(10) Pub. No.: US 2023/0130500 A1
(43) Pub. Date: Apr. 27, 2023

(54) MULTI-MACHINE AND PERFORMANCE BASED CONTINUOUS PRODUCTION PLANNING GLOBAL OPTIMIZATION SCHEDULING METHOD AND DEVICE

(71) Applicant: Pusan National University Industry-University Cooperation Foundation, Busan (KR)

(72) Inventors: Yoon Ho CHOI, Busan (KR); Jin Myeong SHIN, Busan (KR); Jae Seok KIM, Busan (KR)

(21) Appl. No.: 17/896,087

(22) Filed: Aug. 26, 2022

(30) Foreign Application Priority Data
Oct. 25, 2021 (KR) 10-2021-0142572

(51) Int. Cl. G06F 9/48; G06F 9/22

(52) U.S. Cl. CPC G06F 9/4887; G06F 9/223; G06F 9/485

(57) ABSTRACT

A multi-machine and performance based continuous production planning global optimization scheduling method and device are disclosed. The device for multi-machine and performance-based continuous production planning global optimization scheduling may include a data pre-processing module configured to generate a multi-machine list on performable multiple machines through pre-processing scheduling target data, a scheduling module configured to generate a scheduling result by setting a processing time for a machine related to a single machine list, wherein the single machine list is selected from the multi-machine list, and a data post-processing module configured to store the scheduling result in a database.

### CROSS-REFERENCE TO RELATED APPLICATION

This application claims the benefit of Korean Patent Application No. 10-2021-0142572 filed on Oct. 25, 2021, in the Korean Intellectual Property Office, the entire disclosure of which is incorporated herein by reference for all purposes.

### BACKGROUND

### 1. Field of the Invention

The disclosure relates to a multi-machine and performance based continuous production planning global optimization scheduling method and device for storing a scheduling result in a server, allowing continuous scheduling by reflecting the stored scheduling result in the next scheduling, and allowing scheduling that is based on multi-machine and reflects performance of the multi-machine.

### 2. Description of the Related Art

Production plan scheduling may be a task to establish a production plan for products with various elements, such as a process, a process order, a processing time, and a machine.

However, since the production plan needs to consider various conditions, such as different process plans for each product group, a machine for each process, etc., there is a limit in the production plan scheduling.

A task scheduling optimization problem (e.g., a job shop scheduling problem, hereafter, referred to as a JSSP) has been developed in the manufacturing and production field as well as the computer and science field.

A production planning scheduling method may refer to a technique to solve the JSSP in the product manufacturing and production field.

An element of the JSSP may include a job, an operation, a machine, a sequence, and a duration.

In the manufacturing and production field, the job may correspond to a product, the operation may correspond to a process, the machine may correspond to a machine, the sequence may correspond to a process order, and the duration may correspond to a processing time.

The definition of relationship and constraints between the elements in the JSSP are as follows.
A product (e.g., a job) includes various processes (e.g., operations) and the order of operations includes a process order (e.g., a sequence).
The operation is performed by one machine. Accordingly, various operations may not be performed in one machine.
The relationship among products (e.g., jobs) is independent. In other words, there is no rule on which product (e.g., a job) should be produced first.
All products (e.g., jobs) to be scheduled should not be in production progress at the time of scheduling and all machines may not operate at the time of scheduling.

The prior art of solving the JSSP may include, for example, various meta heuristic methods, such as Tabu search and a genetic algorithm, a heuristic method, and a mathematical method based on constraint programming (CP).

The heuristic method may have the advantage of outputting a global optimization result since the unique work know-how is applicable to each application field. However, the heuristic method may have the disadvantage that all scheduling algorithms need to be directly designed and consumes a considerable time for scheduling.

On the other hand, the meta heuristic method is a method that applies an algorithm, which is universally applicable to various fields, to the JSSP, and thus, algorithm design may be simple. However, the work know-how for the field may not be applied to the meta heuristic method and the meta heuristic method may output a local optimization result by searching based on experience.

The CP-based mathematical method may provide high accessibility and convenience since the CP-based mathematical method outputs an optimal schedule among various schedules satisfying various conditions for scheduling through arithmetic, logic, and comparison operations. However, defining a condition may be not simple and a mathematically undefined condition may be not solved.

As described above, there are many methods of scheduling and since each method has advantages and disadvantages, in the manufacturing and production field, a hybrid method using two or more methods together may be used.

In the JSSP, since the condition or the relationship between elements is defined based on task scheduling in the computer field, the condition or the relationship may be difficult to apply to the manufacturing and production field and the prior solving method needs to be modified.

Typically, in the manufacturing and production field, there is a case where some processes in a product need to be performed only in a predetermined period. In addition, in the manufacturing and production field, there is a condition that requires to finish product production or a process in the product.

In addition to a required condition in the JSSP, a defined condition for scheduling in the manufacturing and production field is below.
Each process has a deadline and no process should be scheduled after the deadline.
A process of which a production period is fixed is excluded from scheduling. In addition, a different process should not be scheduled in a machine with a fixed production period.

Since the CP-based mathematical method is convenient to define the condition and the relationship between elements, a condition defined for scheduling may be easily reflected.

However, a condition that cannot be mathematically defined, such as arithmetic, logic, and a comparison operation, may be impossible to be reflected and may need to be solved by adding an algorithm other than the scheduling algorithm.

First of all, some of the constraint conditions of the JSSP may not be applicable to the actual manufacturing and production-related industry because some machines are in operation or some processes are in progress at the time of scheduling. In the CP-based mathematical method, the constraint condition of the JSSP may be not defined and may need to be solved through scheduling data pre-processing.

Secondly, when there are several machines that may perform processes of the product, an optimized scheduling result may be output by considering all machines. In the CP-based mathematical method, several machine processing may be not considered in a scheduling process and an individual multi-machine processing may be needed.

Thirdly, in the actual product manufacturing and production field, a company may determine objectively or subjectively the performance of the machine. The performance of the machine may change a processing time of a process to be scheduled and may affect a scheduling result.

When this factor is not considered, the following two cases may occur due to a large difference between the scheduling result and the actual task result.

First of all, a process assigned to a machine with excellent performance may finish the actual task, compared to an expected result (e.g., the schedule), and may rest until the next task.

Secondly, in case of a machine with low performance, a task may be finished later than expected and the next scheduled process may be affected.

In the current manufacturing and production field, when this case occurs, an inefficient processing method that changes a processing time of the process and newly performs scheduling has been used.

Therefore, there is a demand for a method of production planning optimization scheduling based on the performance of a machine for continuous scheduling in the product production scheduling.

### SUMMARY

Example embodiments provide, for multiple machines, a multi-machine and performance based continuous production planning global optimization scheduling method and device that allows scheduling reflecting the performance of each machine and allows continuous scheduling by reflecting a scheduling result in the next scheduling.

According to an aspect, there is provided a device for multi-machine and performance-based continuous production planning global optimization scheduling including a data pre-processing module configured to generate a multi-machine list on performable multiple machines through pre-processing scheduling target data, a scheduling module configured to generate a scheduling result by setting a processing time for a machine related to a single machine list, wherein the single machine list is selected from the multi-machine list, and a data post-processing module configured to store the scheduling result in a database.

According to an aspect, there is provided a method of multi-machine and performance-based continuous production planning global optimization scheduling including generating a multi-machine list on performable multiple machines through pre-processing scheduling target data, generating a scheduling result by setting a processing time for a machine related to a single machine list, wherein the single machine list is selected from the multi-machine list, and storing the scheduling result in a database.

According to example embodiments, for multiple machines, a multi-machine and performance based continuous production planning global optimization scheduling method and device that allows scheduling reflecting the performance of each machine and allows continuous scheduling by reflecting a scheduling result in the next scheduling may be provided.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is block diagram illustrating a device for global optimization of continuous production planning based on multi-machine and performance;

FIG. 2 is a diagram illustrating a configuration and an operation order of a device for global optimization of continuous production planning;

FIG. 3 is a diagram illustrating a configuration of a data post-processing module;

FIG. 4 is a diagram illustrating a processing time resetting algorithm;

FIG. 5 is a diagram illustrating a processing time resetting algorithm based on machine performance;

FIG. 6 is a diagram illustrating an example of classifying multiple machines; and

FIG. 7 is a flowchart illustrating a method of global optimization of continuous production planning based on multi-machine and performance.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

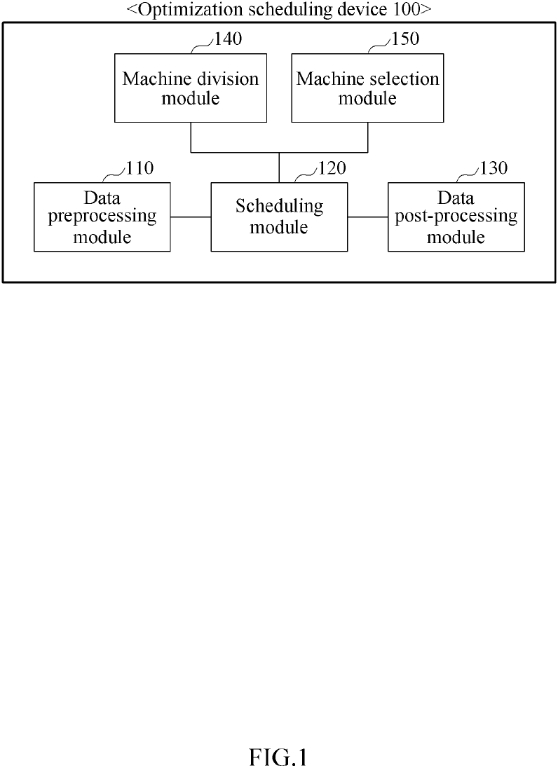

FIG. 1 is block diagram illustrating a device for global optimization of continuous production planning based on multi-machine and performance.

Referring to FIG. 1, the device for global optimization of continuous production planning based on multi-machine and performance 100 (hereinafter, referred to as the optimization scheduling device 100) may include a data pre-processing module 110, a scheduling module 120, and a data post-processing module 130. In addition, the optimization scheduling device 100 may selectively include a machine division module 140 and a machine selection module 150.

The data pre-processing module 110 may generate a multi-machine list on performable multiple machines through pre-processing scheduling target data. For scheduling data input to the data pre-processing module 110, the data pre-processing module 110 may remove data including partially omitted information or distorted information and may select data in a defined type.

The scheduling target data may include at least one of a product, a process, a process order, a process time, a machine, a process start/completion date, whether the process time is fixed, and a scheduling history.

The data pre-processing module 110 may analyze information included in the scheduling target data and based on an analysis result, may filter undefined data and select defined data only.

By using the selected data selected by pre-processing, the data pre-processing module 110 may search for several performable machines on a process related to the scheduling target data and may generate a multi-machine list by listing the several performable machines.

For example, when the scheduling target data for a drilling process to drill a hole in a tool is input to the data pre-processing module 110, the data pre-processing module 110 may select, through pre-processing the scheduling target data, a drill machine A and a drill machine B that may perform the drilling process, may generate a single machine list including a processing time and a processing order for each of the drill machine A and the drill machine B, and may generate a multi-machine list by listing single machine lists.

For a predetermined single machine list selected from the multi-machine list, the scheduling module 120 may generate a scheduling result by setting a processing time for the machine related to the single machine list. The scheduling module 120 may generate a scheduling result by designing an optimized processing time of a predetermined machine for performing a requested process.

The scheduling module 120 may extract a previous scheduling result prestored in a database and may modify preassigned data of the machine by reflecting the extracted previous scheduling result in the single machine list.

That is, the scheduling module 120 may draw a scheduling result of a predetermined machine for a currently requested process by reflecting a previous scheduling result of the predetermined machine that performed the same process.

For example, in the example of generating the multi-machine list for the drilling process described above, the scheduling module 120 may perform a modification to reduce the processing time of the drill machine A in the initially generated single machine list for the drill machine A by reflecting the previous scheduling result for the drilling process previously performed by the drill machine A.

In processing time adjustment, the scheduling module 120 may identify a start date of a process in the single machine list after data modification and may reset the processing time of the machine by calculating a decreased processing time by subtracting a scheduling time point (e.g., today) from the start date.

The scheduling module 120 may calculate a difference between the start date of the process included in the single machine list and a date to perform scheduling (e.g., today) and may reset the processing time by decreasing the processing time by the difference when the start date of the process is before today.

On the other hand, when the decreased processing time, obtained by subtracting the scheduling time point (e.g., today) from the start date of the process, is equal to or less than 0, the completion date of the process may be before today, and thus, the scheduling module 120 may remove the preassigned data of the machine and exclude from the scheduling without resetting.

In addition, when the decreased processing time, obtained by subtracting the scheduling time point (e.g., today) from the start date of the process, is equal to or greater than 1, a difference between the start date of the process and today may be large, and thus, the scheduling module 120 may fix a preset processing time of the machine included in the single machine list, without resetting.

The scheduling module 120 may modify the preassigned data of the machine based on reflection of the previous scheduling result, and an example of the modified data may be at least one, which configures the scheduling target data, of a product, a process, a process order, a processing time, a machine, a start/completion date of the process, whether the processing time is fixed, and a scheduling history.

The scheduling module 120 may retrieve the previous scheduling result on a predetermined machine that performed the process in a previous cycle for a product requiring the process, may reflect the previous scheduling result, may modify preassigned data of the predetermined machine, and may adjust the processing time in the machine.

The optimization scheduling device 100 may perform scheduling on the process in the machine by considering the performance of the machine.

The scheduling module 120 may extract the previous scheduling result prestored in a database and may reflect the performance of the machine for an additional process excluding the previous scheduling result by considering the extracted previous scheduling result.

The performance of the machine may be subjectively evaluated by a related worker in advance.

The scheduling module 120 may retrieve the previous scheduling result of the machine that performed the same process and may numerically evaluate the performance of the machine.

Thereafter, the scheduling module 120 may reset the processing time of the machine, based on the reflected performance.

For example, in the example of generating the multi-machine list on the drilling process, the scheduling module 120 may evaluate the performance of the drill machine A from the previous scheduling result and when the performance of the drill machine A is analyzed and the performance of the drill machine A is statistically 1.2 times of that of a typical machine, the scheduling module 120 may modify the processing time of the drill machine A to decrease by 20% from the initially generated single machine list for the drill machine A.

The data post-processing module 130 may store the scheduling result in a database. The data post-processing module 130 may post-process the generated scheduling result to be in a predetermined format and maintain the result in the database.

The data post-processing module 130 may allow the user to clearly identify how the process is performed by visualizing and providing the scheduling result to the user through a visualization module (not shown).

In addition, the optimization scheduling device 100 may select a predetermined single machine list from the multi-machine list and may perform scheduling on the selected single machine list.

The scheduling module 120 may selectively include the machine division module 140 and the machine selection module 150.

The machine division module 140 may receive an input on the multi-machine list from the data pre-processing module 110 and may classify a plurality of single machine lists based on the number of cases for a process (e.g., task) and a machine in the multi-machine list.

The machine division module 140 may classify the plurality of single machine lists corresponding to all possible number of cases obtained by crossing the process and the machine.

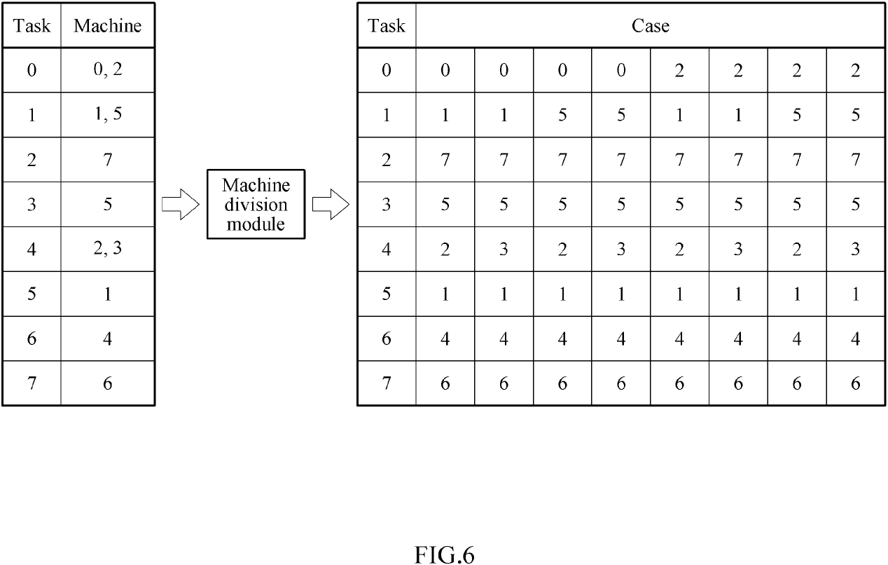

FIG. 6, which is described below, illustrates an example of classifying eight single machine lists according to eight cases by the machine division module 140 when tasks “0 / 1 / 2 / 3 / 4 / 5 / 6 / 7” and machines “0,2 / 1,5 / 7 / 5 / 2,3 / 1 / 4 / 6” are included in the multi-machine list.

In addition, the machine selection module 150 may select a predetermined single machine list from the plurality of single machine lists and may return the predetermined single machine list to the scheduling module 120. The machine selection module 150 may select, from the classified single machine lists, the predetermined single machine list as a scheduling target according to a predetermined procedure and may provide the selected single machine list to the scheduling module 120.

The predetermined procedure may be, for example, a classified order. FIG. 6, which is described below, illustrates an example of selecting a predetermined single machine list according to a classified order that is newly set from task 0 to task 7.

The present disclosure may provide a multi-machine and performance based continuous production planning global optimization scheduling method and device that allows scheduling reflecting the performance of each machine for multiple machines and allows continuous scheduling by reflecting a scheduling result in the next scheduling.

In the conventional manufacturing and production field, there is a problem that continuous scheduling in product production scheduling may be impossible.

To solve this problem, a task that stores the scheduling result in a server and enables continuous scheduling by reflecting the stored scheduling result in the next scheduling may be required.

In addition, in the conventional manufacturing and production field, a local optimization schedule may be output since multiple machines are not considered and there is a problem that the actual task performance result may be different from the scheduling result since the performance of the machine is not considered in the scheduling process.

To solve this problem, scheduling based on multiple machines and the performance thereof may be needed.

To implement a system that compensates for conventional problems, the optimization scheduling device 100 in the present disclosure may perform the following processes.
a data pre-processing process to enable scheduling by reflecting the previous scheduling result and performance of the machine.
a data post-processing process to store and visualize the scheduling result.
a multi-machine classification and processing process to output an optimization schedule for multiple machines.

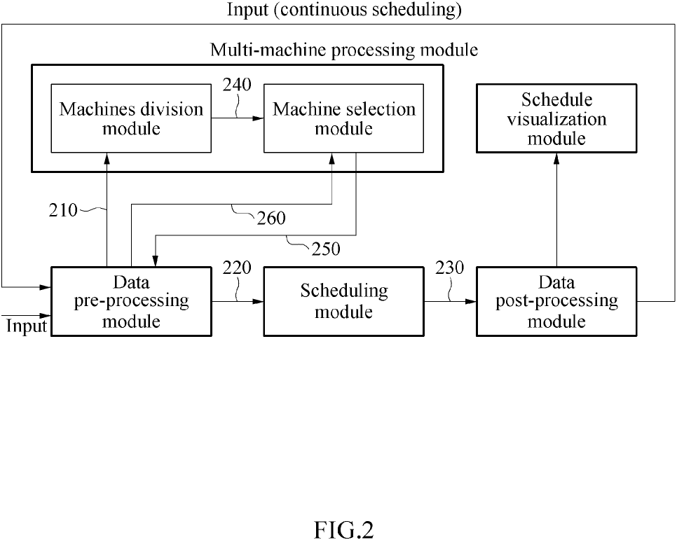

FIG. 2 is a diagram illustrating a configuration and an operation order of a device for global optimization of continuous production planning.

FIG. 2 illustrates a configuration and an operation order of the optimization scheduling device 100 of the present disclosure.

FIG. 2 may include a scenario (e.g., operations 210 to 230) for solving a conventional non-continuous scheduling problem and reflecting performance of a machine in the scheduling and a scenario (e.g., operations 240 to 260) for multi-machine processing.

The scenario of the proposed method to solve a non-continuous scheduling problem and reflecting performance of a machine is described below.

Operation 210 may be an operation of pre-processing scheduling target data by a data pre-processing module that receives the scheduling target data and transmitting preprocessed data to a multi-machine processing module.

In operation 210, the data pre-processing module may receive the scheduling target data (for example, a product, a process, a process order, performable multiple machines, a processing time, a due date, a minimum start date of the process, whether the processing time is fixed, a scheduling history, etc.) and may transmit, to the multi-machine processing module, a multi-machine list listing the performable multiple machines through pre-processing.

Operation 220 may be an operation of receiving, by the data pre-processing module, a result returned from the multi-machine processing module and reflecting the result in data.

In operation 220, the data pre-processing module may reflect the result returned from the multi-machine processing module in the input scheduling target data, may join the result returned from the multi-machine processing module with the previous scheduling result, and may modify the data based on the scheduling time point.

In addition, the data pre-processing module may reset the processing time based on the performance of the machine and may input a final scheduling result to a scheduling module.

Operation 230 may be an operation of receiving, by a data post-processing module, the final scheduling result from the scheduling module and providing the result to a scheduling visualization module.

In addition, the data post-processing module may keep the final scheduling result in a server and may allow use of the data in the data post-processing module when subsequent data is input.

In operation 230, the data post-processing module may receive the final scheduling data from the scheduling module, may visualize the schedule, and may store the visualized data schedule in the server for the next scheduling according to an input data format.

The optimization scheduling device 100 may perform continuous production planning scheduling and may solve the conventional non-continuous scheduling problem by performing operations 210 to 230.

In addition, the optimization scheduling device 100 may reduce a difference between an existing scheduling result and an actual task result by reflecting the performance of the machine in the data pre-processing process.

The multi-machine processing scenario is described below.

Operation 240 may be an operation of, in a machine division module in the multi-machine processing module, receiving a multi-machine list generated by pre-processing by the data pre-processing module and transmitting the multi-machine list to a machine selection module in the multi-machine processing module. The machine selection module may select a predetermined single machine list to perform from the transmitted multi-machine list.

In operation 240, the multi-machine processing module may convert the multi-machine list on performable multiple machines into a single machine list.

Operation 250 may be an operation of transmitting the selected single machine list in the machine selection module to the data pre-processing module.

In operation 250, the multi-machine processing module may return the selected single machine list to the data pre-processing module.

When a final scheduling result is generated by performing previous operations 220 and 230 related to the returned single machine list, operation 260 may be an operation of selecting the next single machine list from the data pre-processing module to the multi-machine processing module.

In operation 260, when scheduling for data reflecting the single machine list is completed, the data pre-processing module may request the multi-machine processing module to select another single machine list and may receive the other single machine list.

Operations 250 and 260 may be repeated until reaching a user-defined maximum scheduling time or returning all single machine lists.

The optimization scheduling device 100 may perform optimized scheduling by performing operations 240 to 260 and through this, may solve a local optimization schedule finding problem.

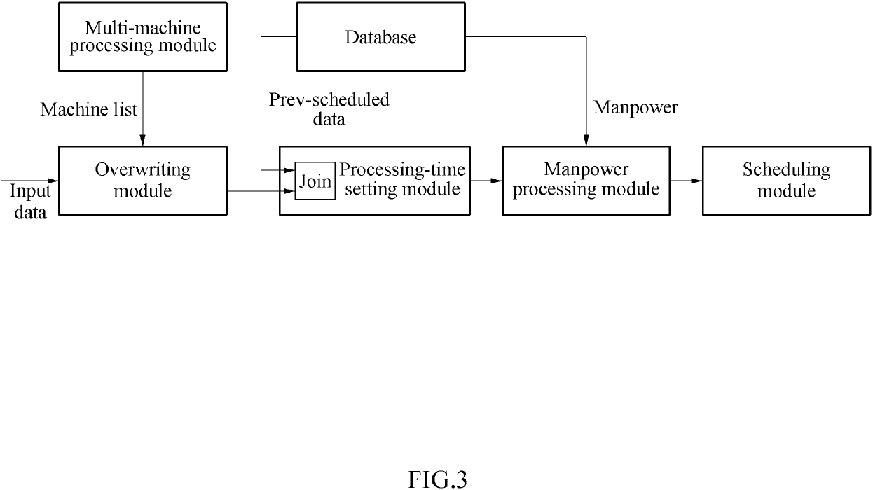

FIG. 3 is a diagram illustrating a configuration of a data post-processing module.

FIG. 3 illustrates a configuration of the data post-processing module.

As illustrated in FIG. 3, the data post-processing module may include an overwriting module, a processing time setting module, a manpower processing module, and a scheduling module.

The overwriting module may write input data (e.g., a product, a process, a sequence, performable multiple machines, a processing time, a due date, a minimum start date of the process, whether the processing time is fixed, and a scheduling history) in a single machine list returned from the multi-machine processing module.

Thereafter, the processing time setting module may retrieve previous scheduling data (e.g., prev-scheduled data) stored in a database (e.g., a server) and may join the previous scheduling data (e.g., prev-scheduled data) stored in the database with the single machine list including the input data.

In addition, the manpower processing module may retrieve manpower stored in the database (e.g., the server) and may reflect the manpower in data input by the processing time setting module.

The scheduling module may reset a processing time based on the scheduling time point for the data reflecting the manpower.

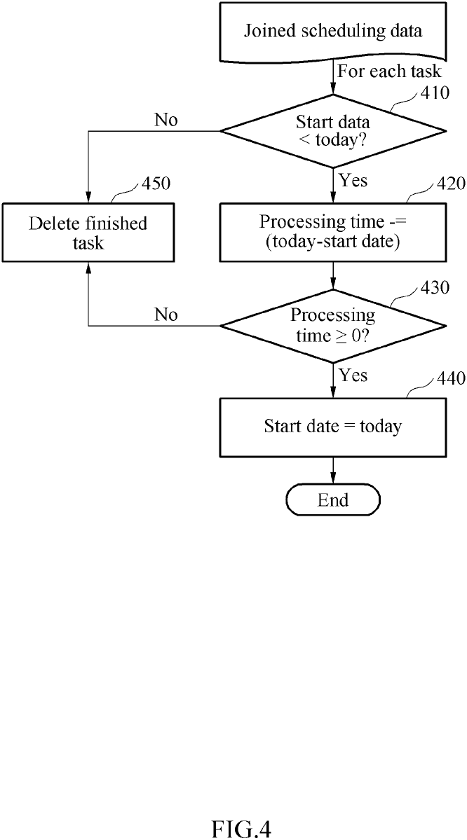

FIG. 4 is a diagram illustrating a processing time resetting algorithm.

In operation 410, for scheduling data and data reflecting manpower (e.g., joined scheduling data), the scheduling module may determine whether a start date is before today (e.g. Start Date < Today?).

When the start date is before today (e.g., the “yes” direction of operation 410), in operation 420, the scheduling module may calculate a processing time (e.g., processing time = today - start date).

In operation 430, the scheduling module may identify whether the calculated processing time remains (e.g., processing time ≥ 0).

When there is processing time remaining (e.g., the “yes” direction of operation 430), in operation 440, the scheduling module may reset the start date to today (e.g., start date = today).

On the other hand, when the start date is not before today (e.g., the “no” direction of operation 410) or there is no remaining processing time (e.g., the “no” direction of operation 430), in operation 450, the scheduling module may delete a finished task.

In summary, when receiving a new product production order and scheduling, the start date of some tasks in the prior schedule may precede the scheduling time point (e.g., today). In this case, the tasks may be considered to be already in progress.

Accordingly, the scheduling module may calculate an elapsed period from the start date of the task to the scheduling time point (today) and may reduce the processing time by the calculated elapsed period.

When the reduced processing time is less than or equal to 0, the scheduling module may determine that the task is completed and may remove the task from data.

When the reduced processing time is greater than or equal to 1, the scheduling module may perform scheduling to fix the processing time of the task since the task is still in progress and the processing time needs to be unchanged.

Resetting the processing time based on the scheduling time point may be performed on not only a task determined by the previous scheduling but also newly input data.

Resetting the processing time on the newly input data may be needed to consider a case where a task that the user fails to input is already in progress.

After resetting the processing time based on the scheduling time point, the optimization scheduling device 100 may reset the processing time of the task based on performance of a machine.

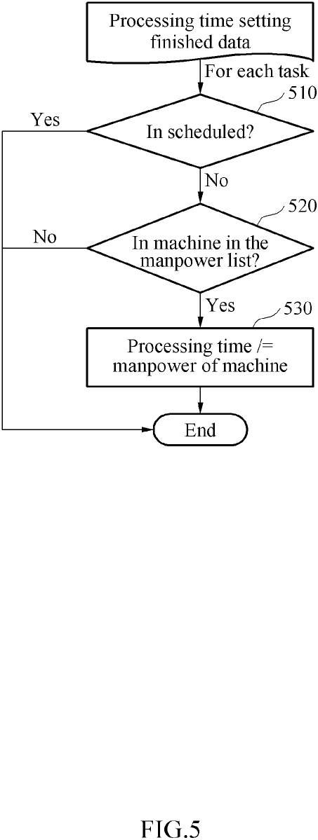

An operation of resetting the processing time based on performance of a machine is described with reference to an algorithm of FIG. 5.

FIG. 5 is a diagram illustrating a processing time resetting algorithm based on machine performance.

In operation 510, the scheduling module may receive processing time setting finished data and may determine whether a task is scheduled.

When the task is not scheduled (e.g., the “no” direction of operation 510), in operation 520, the scheduling module may determine whether there is a machine listed as performable in a manpower list (e.g., Is machine in the manpower list?).

When there is a performable machine (e.g., the “yes” direction of operation 520) in the manpower list, in operation 530, the scheduling module may match a processing time with the machine (e.g., processing time = manpower of machine).

On the other hand, when the task is scheduled (e.g., the “yes” direction of operation 510) or there is no performable machine (e.g., the “no” direction of operation 520) in the manpower list, the scheduling module may terminate resetting the processing time.

In summary, the scheduling module may identify a scheduling history for each task.

When the schedule history is true, the task may be skipped since the processing time has been reset based on the performance of the machine.

On the other hand, when the schedule history is false, the scheduling module may reset the processing time according to a machine assigned to each task, based on the performance of the machine stored in the server.

When the performance of the machine is not stored in the server, the scheduling module may not reset the processing time of the task. For example, when the performance of the machine assigned to a task is 50% and a processing time of the task is 3 days, the scheduling module may set the processing time to 6 days.

In another example, when the performance of the machine assigned to a task is not stored in the server and a processing time of the task is 5 days, the scheduling module may maintain the processing time to be 5 days and perform scheduling.

Preprocessed data may be input to a scheduling algorithm.

Data that is output after scheduling is finished may be stored in two data types (e.g., a data type for visualizing a scheduling result and an input data type) by the data post-processing module.

Visualization of the scheduling result may require flexible data types depending on a visualization tool.

The input data type may be for continuous scheduling and a storage method is described below.

The data post-processing module may store, in the server, a start date of a scheduled task as a minimum start date of the task of the input data. This is for modification by resetting the processing time based on the scheduling time point.

In addition, since the stored input data includes a processing time that has already been reset based on the performance of the machine, the data post-processing module may modify the schedule history to true. When the schedule history is not true, the data post-processing module may reset the processing time in the next scheduling.

Thereafter, the data post-processing module may store other output data in the server to be compliant to the input data type.

Machine assignment may cause a large difference in a scheduling result depending on the performance of the machine. The optimization scheduling device 100 may assign all performable machines for each task and find a global optimization scheduling result.

Accordingly, the optimization scheduling device 100 may require a processing operation to assign one machine for each task before scheduling.

The multi-machine processing module may be configured in the machine division module and the machine selection module.

The machine division module may output multiple machines as single machine lists corresponding to the number of cases for the initially input task.

When the number of machines that may perform a task k among N tasks is fₖ, the number of cases may be

$${\text{∏}}_{K = 1}^{N} {f}_{k}$$

and this may be transmitted to the machine selection module.

FIG. 6 is a diagram illustrating an example of classifying multiple machines.

FIG. 6 is an example of classifying multiple machines.

The machine division module may arbitrarily select one from classified single machine lists, return the selected single machine list to a data pre-processing module, and remove the list from the number of cases.

The operation may be repeated every time scheduling is finished and may be terminated when all lists are traversed or a predetermined time defined by a user is reached.

For example, as illustrated in FIG. 6, the machine division module may classify multiple machines by listing the number of cases for assigned machines to task 0 to task 7 in a single machine list.

By the continuous scheduling method, the present disclosure may solve the conventional inefficiency caused by suspension of work of a machine for each scheduling.

Performance-based scheduling may solve a problem of a difference between the scheduling result and the actual task result due to the performance of the machine.

Global optimization scheduling may solve the conventional problem of outputting a local optimization schedule due to scheduling for a predetermined machine by classifying multiple machines and searching for all possible cases.

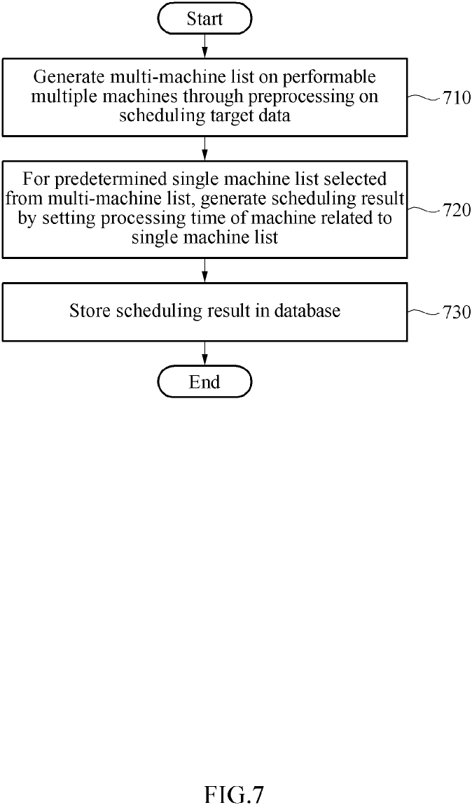

Hereinafter, FIG. 7 describes a flow of implementing the optimization scheduling device 100.

FIG. 7 is a flowchart illustrating a method of global optimization of continuous production planning based on multi-machine and performance.

A method of global optimization scheduling of continuous production planning based on multi-machine and performance may be performed by the optimization scheduling device 100.

In operation 710, the optimization scheduling device 100 may generate a multi-machine list on performable multiple machines through pre-processing scheduling target data. Operation 710 may be an operation, for input scheduling data, of removing data including partially omitted information or distorted information and selecting data in a defined type.

The scheduling target data may include at least one of a product, a process, a process order, a process time, a machine, a process start/completion date, whether the process time is fixed, and a scheduling history.

The optimization scheduling device 100 may analyze information included in the scheduling target data and based on an analysis result, may filter undefined data and select defined data only.

By using the selected data selected by pre-processing, the optimization scheduling device 100 may search for several performable machines on a process related to the scheduling target data and may generate a multi-machine list by listing the several performable machines.

For example, when the scheduling target data for a drilling process to drill a hole in a tool is input to the optimization scheduling device 100, the optimization scheduling device 100 may select, through pre-processing the scheduling target data, a drill machine A and a drill machine B that may perform the drilling process, may generate a single machine list including a processing time and a processing order for each of the drill machine A and the drill machine B, and may generate a multi-machine list by listing the single machine lists.

In addition, in operation 710, for a predetermined single machine list selected from the multi-machine list, the optimization scheduling device 100 may generate a scheduling result by setting a processing time for the machine related to the single machine list. Operation 720 may be an operation of generating a scheduling result by designing an optimized processing time of a predetermined machine for performing a requested process.

Specifically, the optimization scheduling device 100 may extract a previous scheduling result prestored in a database and may modify preassigned data of the machine by reflecting the extracted previous scheduling result in the single machine list.

That is, the optimization scheduling device 100 may draw a scheduling result of a predetermined machine for a currently requested process by reflecting a previous scheduling result of the predetermined machine that performed the same process.

For example, in the example of generating the multi-machine list for the drilling process described above, the optimization scheduling device 100 may perform modification to reduce the processing time of the drill machine A in the initially generated single machine list for the drill machine A by reflecting the previous scheduling result for the drilling process previously performed by the drill machine A.

In processing time adjustment, the optimization scheduling device 100 may identify a start date of a process in the single machine list after data modification and may reset the processing time of the machine by calculating a decreased processing time by subtracting a scheduling time point (e.g., today) from the start date.

The optimization scheduling device 100 may calculate a difference between the start date of the process included in the single machine list and a date to perform scheduling (e.g., today) and may reset the processing time by decreasing the processing time by the difference when the start date of the process is before today.

On the other hand, when the decreased processing time, obtained by subtracting the scheduling time point (e.g., today) from the start date of the process, is equal to or less than 0, the completion date of the process may be before today, and thus, the optimization schedule device 100 may remove the preassigned data of the machine and exclude from the scheduling without resetting.

In addition, when the decreased processing time, obtained by subtracting the scheduling time point (e.g., today) from the start date of the process, is equal to or greater than 1, a difference between the start date of the process and today may be large, and thus, the optimization scheduling device 100 may fix a preset processing time of the machine included in the single machine list, without resetting.

The optimization scheduling device 100 may modify the preassigned data of the machine based on reflection of the previous scheduling result, and an example of the modified data may be at least one, which configures the scheduling target data, of a product, a process, a process order, a processing time, a machine, a start/completion date of the process, whether the processing time is fixed, and a scheduling history.

The optimization scheduling device 100 may retrieve the previous scheduling result on a predetermined machine that performed the process in a previous cycle for a product requiring the process, may reflect the previous scheduling result, may modify preassigned data of the predetermined machine, and may adjust the processing time in the machine.

The optimization scheduling device 100 may perform scheduling on the process in the machine by considering the performance of the machine.

The optimization scheduling device 100 may extract the previous scheduling result prestored in a database and may reflect the performance of the machine for an additional process excluding the previous scheduling result by considering the extracted previous scheduling result.

The performance of the machine may be subjectively evaluated by a related worker in advance.

The optimization scheduling device 100 may retrieve the previous scheduling result of the machine that performed the same process and may numerically evaluate the performance of the machine.

Thereafter, the optimization scheduling device 100 may reset the processing time of the machine, based on the reflected performance.

For example, in the example of generating the multi-machine list on the drilling process, the optimization scheduling device 100 may evaluate the performance of the drill machine A from the previous scheduling result and when the performance of the drill machine A is analyzed and the performance of the drill machine A is statistically 1.2 times of that of a typical machine, the scheduling module 120 may modify the processing time of the drill machine A to decrease by 20% from the initially generated single machine list for the drill machine A.

In operation 730, the optimization scheduling device 100 may store the scheduling result in the database. Operation 730 may be an operation of post-processing the generated scheduling result to be in a predetermined format and maintaining the result in the database.

The optimization scheduling device 100 may allow the user to clearly identify how the process is performed by visualizing and providing the scheduling result to the user through a visualization module (not shown).

In addition, the optimization scheduling device 100 may select a predetermined single machine list from the multi-machine list and may perform scheduling on the selected single machine list.

The optimization scheduling device 100 may receive an input on the multi-machine list and may classify a plurality of single machine lists based on the number of cases for a process (e.g., task) and a machine in the multi-machine list.

The optimization scheduling device 100 may classify the plurality of single machine lists corresponding to all possible number of cases obtained by crossing the process and the machine.

FIG. 6 illustrates an example of classifying eight single machine lists according to eight cases by the optimization scheduling device 100 when tasks “0 / 1 / 2 / 3 / 4 / 5 / 6 / 7” and machines “0,2 / 1,5 / 7 / 5 / 2,3 / 1 / 4 / 6” are included in the multi-machine list.

In addition, the optimization scheduling device 100 may select a predetermined single machine list from the plurality of single machine lists and may return the predetermined single machine list to the scheduling module 120. The optimization scheduling device 100 may select, from the classified single machine lists, the predetermined single machine list as a scheduling target according to a predetermined procedure and may provide the selected single machine list.

The predetermined procedure may be, for example, a classified order. FIG. 6 illustrates an example of selecting a predetermined single machine list according to a classified order that is newly set from task 0 to task 7.

The present disclosure may provide a multi-machine and performance based continuous production planning global optimization scheduling method and device that allows scheduling reflecting the performance of each machine for multiple machines and allows continuous scheduling by reflecting a scheduling result in the next scheduling.

The methods according to the above-described examples may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or pseudo equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A device for multi-machine and performance-based continuous production planning global optimization scheduling, the device comprising:
a data pre-processing module configured to generate a multi-machine list on performable multiple machines through pre-processing scheduling target data;
a scheduling module configured to generate a scheduling result by setting a processing time for a machine related to a single machine list, wherein the single machine list is selected from the multi-machine list; and
a data post-processing module configured to store the scheduling result in a database.

2. The device of claim 1, wherein the scheduling module is configured to:
extract a previous scheduling result prestored in the database, and
modify data, which is preassigned to the machine, of the machine by reflecting the extracted previous scheduling result in the single machine list.

3. The device of claim 2, wherein the scheduling module is further configured to:
identify a start date of a process from the single machine list after data modification,
reset the processing time of the machine by calculating a reduced processing time by subtracting a scheduling time point from the start date of the process, and
when the reduced processing time is less than or equal to 0, remove preassigned data of the machine, and when the reduced processing time is greater than or equal to 1, fix the processing time, which is preset to the machine, of the machine.

4. The device of claim 2, wherein the modified data based on reflection of the previous scheduling result comprises at least one that configures the scheduling target data of a product, a process, a process order, a processing time, a machine, a start date and completion date of the process, whether the processing time is fixed, and a scheduling history.

5. The device of claim 1, wherein the scheduling module is configured to:
extract a previous scheduling result prestored in the database, and
reflect performance of the machine in an additional process excluding the previous scheduling result by considering the extracted previous scheduling result.

6. The device of claim 5, wherein the scheduling module is further configured to reset the processing time of the machine based on the reflected performance of the machine.

7. The device of claim 1, further comprising:
a machine division module configured to receive the multi-machine list from the data pre-processing module and classify a plurality of single machine lists based on the number of cases for a task and a machine in the multi-machine list; and
a machine selection module configured to select a predetermined single machine list from the plurality of single machine lists and return the predetermined single machine list to the scheduling module.

8. A method of multi-machine and performance-based continuous production planning global optimization scheduling, the method comprising:
generating a multi-machine list on performable multiple machines through pre-processing scheduling target data;
generating a scheduling result by setting a processing time for a machine related to a single machine list, wherein the single machine list is selected from the multi-machine list; and
storing the scheduling result in a database.

9. The method of claim 8, further comprising:
extracting a previous scheduling result prestored in the database; and
modifying preassigned data of the machine by reflecting the extracted previous scheduling result in the single machine list.

10. The method of claim 9, further comprising:
identifying a start date of a process from the single machine list after data modification; and
resetting the processing time of the machine by calculating a reduced processing time by subtracting a scheduling time point from the start date of the process,
wherein the resetting comprises:
when the reduced processing time is less than or equal to 0, removing preassigned data of the machine; and
when the reduced processing time is greater than or equal to 1, fixing the processing time, which is preset to the machine, of the machine.

11. The method of claim 9, wherein the modified data based on reflection of the previous scheduling result comprises at least one that configures the scheduling target data of a product, a process, a process order, a processing time, a machine, a start date and completion date of the process, whether the processing time is fixed, and a scheduling history.

12. The method of claim 8, further comprising:
extracting a previous scheduling result prestored in the database; and
reflecting performance of the machine in an additional process excluding the previous scheduling result by considering the extracted previous scheduling result.

13. The method of claim 12, further comprising:
resetting the processing time of the machine based on the reflected performance of the machine.

14. The method of claim 8, further comprising:
receiving the multi-machine list from a data pre-processing module and classifying a plurality of single machine lists based on the number of cases for a task and a machine in the multi-machine list; and
selecting a predetermined single machine list from the plurality of single machine lists and returning the predetermined single machine list to the scheduling module.

15. A non-transitory computer-readable storage medium storing instructions that, when executed by a processor, cause the processor to perform the method of claim 8.
